(19) United States
(12) Patent Application Publication
(10) Pub. No.: US 2019/0227678 A1
(43) Pub. Date: Jul. 25, 2019

(54) PROVIDING DOCUMENT FEATURE MANAGEMENT IN RELATION TO COMMUNICATION

(71) Applicant: Microsoft Technology Licensing, LLC, Redmond, WA (US)

(72) Inventors: Alexander W. DARROW, Bellevue, WA (US); Philip Z. LOH, Redmond, WA (US); Shahil SONI, Redmond, WA (US)

(21) Appl. No.: 16/367,723

(22) Filed: Mar. 28, 2019

Related U.S. Application Data
(62) Division of application No. 15/347,802, filed on Nov. 10, 2016.

(51) Int. Cl. G06F 3/0482; H04L 29/08; H04L 12/58

(52) U.S. Cl. CPC G06F 3/0482; H04L 67/04; H04L 51/18; G06F 17/2205; H04L 51/08; H04L 51/046; H04L 67/10

(57) ABSTRACT

Variety of approaches to provide document feature management in relation to a communication are described. A productivity application initiates operations to present a communication through a productivity application user interface (UI). The communication includes an attachment file. Upon receiving a modification for the attachment file, the attachment file is renamed based on the modification. An instruction is also transmitted to a data store associated with the communication to rename the attachment file based on the modification. Alternatively, in response a request to create a cloud hosted file, the cloud hosted file is created as related to the communication. A property of the cloud hosted file is also configured based on a property of the communication. The cloud hosted file is furthermore associated with a group associated with the communication.

### RELATED APPLICATIONS

This application is a divisional application of U.S. application Ser. No. 15/347,802 filed Nov. 10, 2016, the entire content of which is incorporated by reference herein.

### BACKGROUND

Information collection, management, and analysis have changed work processes and associated data management. Automation and improvements in work processes have expanded scope of capabilities offered by businesses. With the development of faster and smaller electronics, execution of mass processes at data analysis systems have become feasible. Indeed, analysis work at data centers, data warehouses, data workstations have become common experience in modern work and personal environments. Such systems provide a wide variety of applications such as communication applications rendering communications. Many such applications provide communications to attempt to improve consumption of information. Communication management and transmission consume significant resources and performance at a promise of improved processes and condensed task flows.

Improved communication management techniques are becoming ever more important as communication complexity increases across the computer industry. Variety of techniques are necessary to process a communication, to present the communication, and to maintain the communication. There are currently significant gaps when providing attachment functionality and when providing cloud hosted file in relation to a communication. Lack of relevant document management methods in relation to a communication lead to poor management of the communication.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing document feature management in relation to a communication. A productivity application, according to embodiments, may initiate operations to provide document feature management by presenting a communication through a productivity application user interface (UI). The communication may include an attachment file. Upon receiving a modification for the attachment, the attachment file may be renamed based on the modification. Next, an instruction may be transmitted to a data store associated with the communication to rename the attachment file based on the modification.

In an alternative scenario, the productivity application may receive a request to create a cloud hosted file associated with a communication. In response to the request, the cloud hosted file may be created in relation to the communication. Next, a property of the cloud hosted file may be configured based on a property of the communication. The cloud hosted file may also be associated with a group associated with the communication.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing document feature management in relation to a communication, according to embodiments;

FIG. 2 is a display diagram illustrating example components of a user interface of a productivity application that provides document feature management in relation to a communication, according to embodiments;

FIG. 3 is a display diagram illustrating components of an alternative scheme to provide document feature management in relation to a communication, according to embodiments;

FIG. 4 is a display diagram illustrating another example scenario of the alternative scheme to provide document feature management in relation to a communication, according to embodiments;

FIG. 5 is a simplified networked environment, where a system according to embodiments may be implemented;

FIG. 6 is a block diagram of an example computing device, which may be used to provide document feature management in relation to a communication, according to embodiments;

FIG. 7 is a logic flow diagram illustrating a process for providing document feature management in relation to a communication, according to embodiments; and

FIG. 8 is another logic flow diagram illustrating another process for providing document feature management in relation to a communication, according to embodiments.

### DETAILED DESCRIPTION

As briefly described above, a productivity application may provide document feature management in relation to a communication. In an example scenario, the productivity application, which may include a communication application, may present a communication through a productivity application user interface (UI). An example of the communication may include an email, a text based message, and/or a multi-modality communication with text components, among others. The communication may also include an attachment file. An example of the attachment file may include a document.

The productivity application may receive a modification for the attachment file. The modification may include an edit action to rename the attachment file. In response to the modification, the attachment file may be renamed based on the modification. Next, an instruction may be transmitted to a data store associated with the communication to rename the attachment file based on the modification. The data store may be prompted to rename the attachment file. As a result, any local cache(s) of the attachment file provided by other client application(s) may be updated to reflect the modification to the name of the attachment file.

In an alternative scenario, the productivity application may receive a request to create a cloud hosted file associated with a communication. An example of the cloud hosted file may include a document managed by a distributed computing source. In response to the request, the cloud hosted file may be created in relation to the communication. A relationship between the communication and the cloud hosted file may be established based on inherited property(s). Next, a property of the cloud hosted file may be configured based on a property of the communication. For example, the cloud hosted file may be named based on a subject of the communication. The cloud hosted file may also be associated with a group associated with the communication. The group may include recipient(s) of the communication.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide document feature management in relation to a communication. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

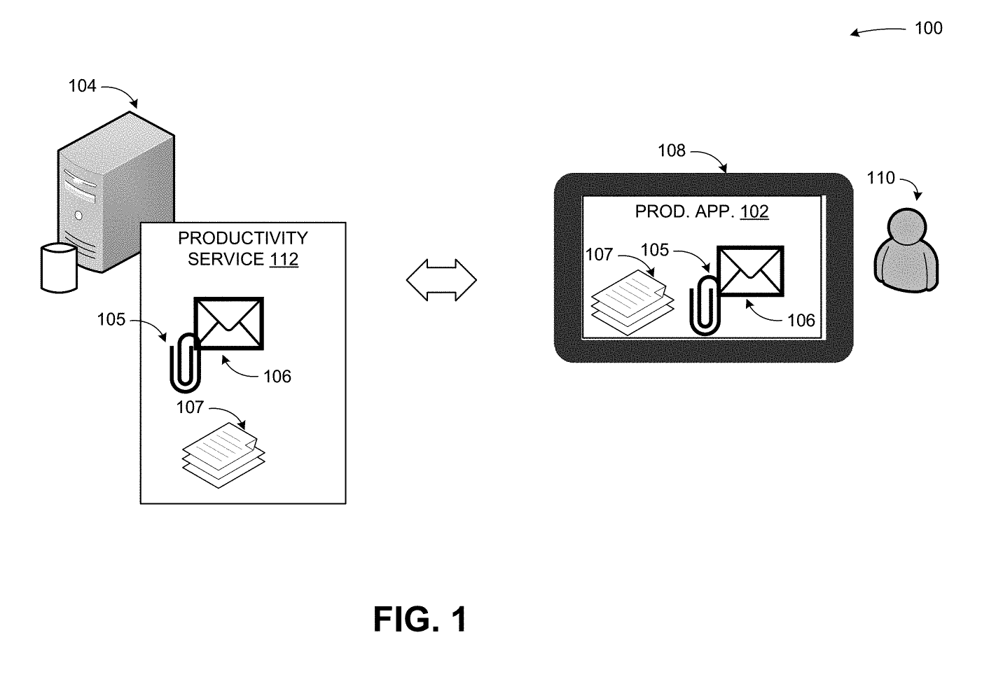

FIG. 1 is a conceptual diagram illustrating examples of providing document feature management in relation to a communication, according to embodiments.

In a diagram 100, a computing device 108 may execute a productivity application 102. The productivity application 102 may include a communication application. The computing device 108 may include a physical computer and/or a mobile computing device such as a smart phone and/or similar ones. The computing device 108 may also include a special purpose and/or configured device that is optimized to execute data operations associated with the productivity application 102. For example, the computing device 108 may include physical components that are custom built to accelerate operations associated with a communication and/or a related document with multiple computation cores tailored to process number of data streams associated with the communication and/or the related document.

The computing device 108 may execute the productivity application 102. The productivity application 102 may initiate operations to provide document feature management by presenting a communication 106 through a productivity application UI. An example of the communication 106 may include an email, a text based message, and/or a multi-modality communication with text components, among others. The communication 106 may also include an attachment file 105. An example of the attachment file 105 may include a document.

Next, the productivity application 102 may receive a modification for the attachment file 105. The modification may include an edit action to rename the attachment file 105. The modification may also include an activation of a rename element from a menu UI presented in relation to the attachment file 105. The rename element may include operations to rename the attachment file 105.

In response to the modification, the attachment file 105 may be renamed based on the modification. Next, an instruction may be transmitted to a data store 104 associated with the communication 106 to rename the attachment file 105 based on the modification. The data store may provide a productivity service 112 that hosts the attachment file 105 as well as the communication 106. For example, the data store may include a physical productivity server that facilitates transmission of the communication 106 and/or the attachment file 105 from/to the productivity application 102. Furthermore, the data store 104 may also be prompted to rename the attachment file 105. As a result, any local cache(s) of the attachment file 105 provided by other client application(s) may be updated to reflect the modification in the name of the attachment file 105.

In an alternative scenario, the productivity application 102 may receive a request to create a cloud hosted file 107 associated with the communication 106. An example of the cloud hosted file 107 may include a document managed by a distributed computing source such as the data store 104.

In response to the request, the cloud hosted file 107 may be created in relation to the communication 106. A relationship between the communication 106 and the cloud hosted file 107 may be established based on inherited property(s). Next, a property of the cloud hosted file 107 may be configured based on a property of the communication 106. For example, the cloud hosted file 107 may be named based on a subject of the communication 106. The cloud hosted file 107 may also be associated with a group associated with the communication 106. The group may include recipient(s) of the communication 106.

The computing device 108 may communicate with other client device(s) or server(s) through a network. The network may provide wired or wireless communications between network nodes such as the computing device 108, other client device(s) and/or server(s) such as the data store 104, among others. Previous example(s) to provide document feature management in relation to the communication 106 by the productivity application 102 are not provided in a limiting sense. Alternatively, the productivity service 112 may provide document feature management in relation to the communication 106. Furthermore, the productivity service 112 may provide the productivity application 102 as a client interface for execution by the computing device 108.

A recipient 110 may interact with the productivity application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 108, the productivity application 102, embodiments are not limited to these components or system configurations and can be implemented with other system configuration employing fewer or additional components.

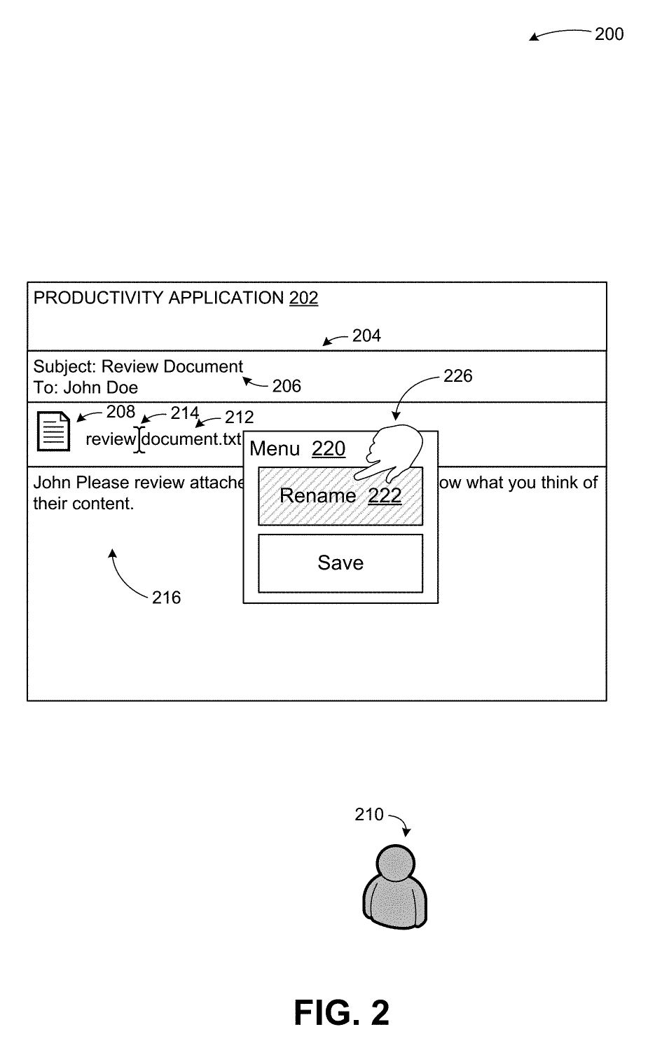

FIG. 2 is a display diagram illustrating example components of example components of a user interface of a productivity application that provides document feature management in relation to a communication, according to embodiments.

In a diagram 200, a rendering engine of a productivity application 202 may present a communication 204. An example of the communication 204 may include an email, a text based message, and/or a multi-modal communication with a text component, among others. The communication 204 may include property(s). An example of a property of the communication may include a subject 206. The communication 204 may also include an attachment file 208 and a content 216. An example of the attachment file 208 may include a document. The content 216 may include text, image, audio, video, and/or similar ones.

In an example scenario, the productivity application 202 may provide an indication that a name 212 of the attachment file 208 may be modifiable. For example, in response to an interaction by a recipient 210 with the attachment file 208, the productivity application 202 may provide a marker (overlaid on the name 212 of the attachment file 208) to indicate that the name 212 may be modifiable. The marker may include an animation, a cursor 214, among others.

The productivity application 202 may provide the name 212 of the attachment file 208 as an editable string. In response to detecting an edit action (provided by the recipient 210) on the editable string, the edit action may be applied to the name 212 to rename the attachment file 208 based on the edit action.

Alternatively, the productivity application 202 may provide a menu UI 220 in response to another interaction by the recipient 210 with the attachment file 208. The productivity application 202 may also detect an activation 226 (by the recipient 210) of a menu element 222 (within the menu UI 220). The menu element 222 may include operations to rename the name 212 of the attachment file 208. In response to the activation 226, the productivity application 202 may provide a UI element such as the cursor 214 to allow the recipient to rename the name 212 of the attachment file 208. Upon detecting an action on the cursor 214, the action may be applied to the attachment file 208 to rename the name 212 of the attachment file 208.

The attachment file 208 may be stored by a data store associated with the communication 204. As such, upon detecting an action to rename the name 212 of the attachment file 208, the productivity application 202 may instruct the data store to rename the attachment file 208 based on the action. A local cache of the attachment file 208 may also be renamed to update a presentation of the attachment file 208 based on the modification action. Furthermore, the data store may also be instructed to prompt another client application (that provides the attachment file 208) to rename a local cache of the attachment file 208 based on the modification action. As such, a change in the name 212 of the attachment file 208 is propagated to any client application that presents the attachment file 208, through the data store that hosts the attachment file 208.

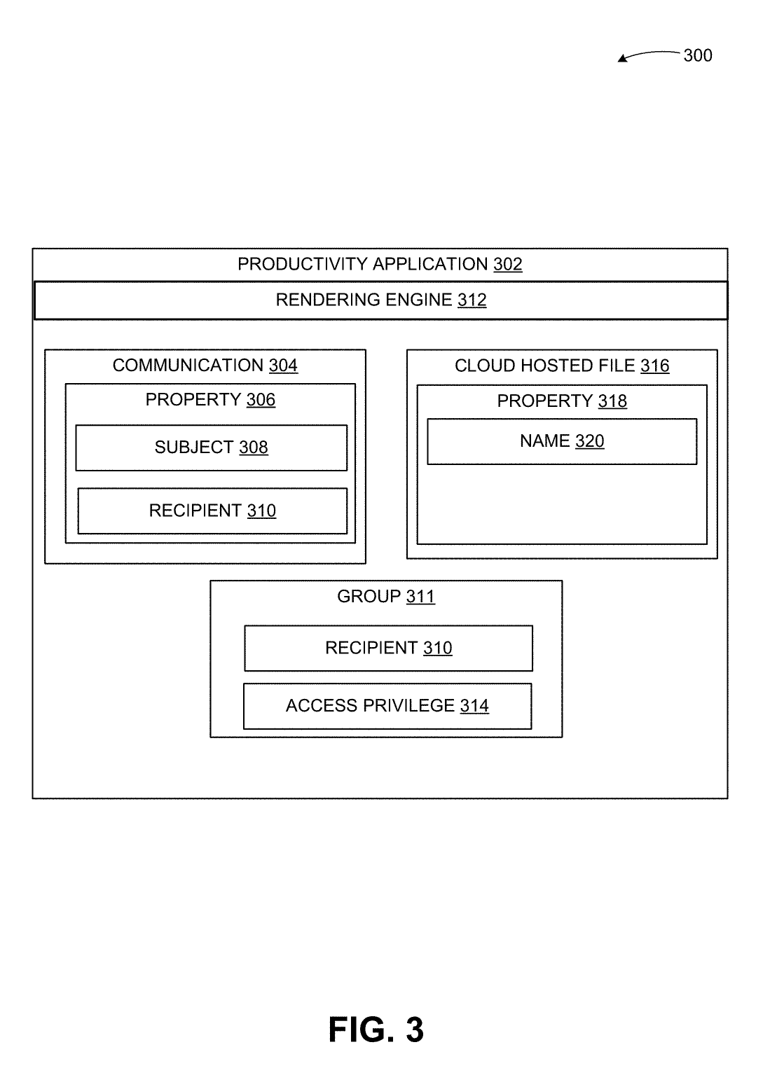

FIG. 3 is a display diagram illustrating components of an alternative scheme to provide document feature management in relation to a communication, according to embodiments.

In a diagram 300, a rendering engine 312 of a productivity application 302 may receive a request to create a cloud hosted file 316 associated with a communication 304. An example of the cloud hosted file 316 may include a document hosted by a distributed computing source.

The communication 304 may include a property such as a subject 308 and a recipient 310, among others. The cloud hosted file 316 may be created based on a relationship with the communication 304. While creating the cloud hosted file 316, a property 318 of the cloud hosted file 316 may be configured based on a property 306 of the communication 304. For example, a name 320 of the cloud hosted file 316 may be based on a subject 308 of the communication 304.

Furthermore, the cloud hosted file 316 may be associated with a group 311 associated with the communication 304. The group 311 may include recipients of the communication. Furthermore, the group 311 may include participants in a conversation that encompasses the communication 304. A relationship between the cloud hosted file 316 and the group 311 may be established based on a detected participation between the members of the group 311 in the communication 304 and/or a conversation encompassing the communication 304. The group 311 may be granted an access privilege 314 to modify the cloud hosted file. The access privilege 314 may allow the group 311 to collaborate on editing the cloud hosted file 316.

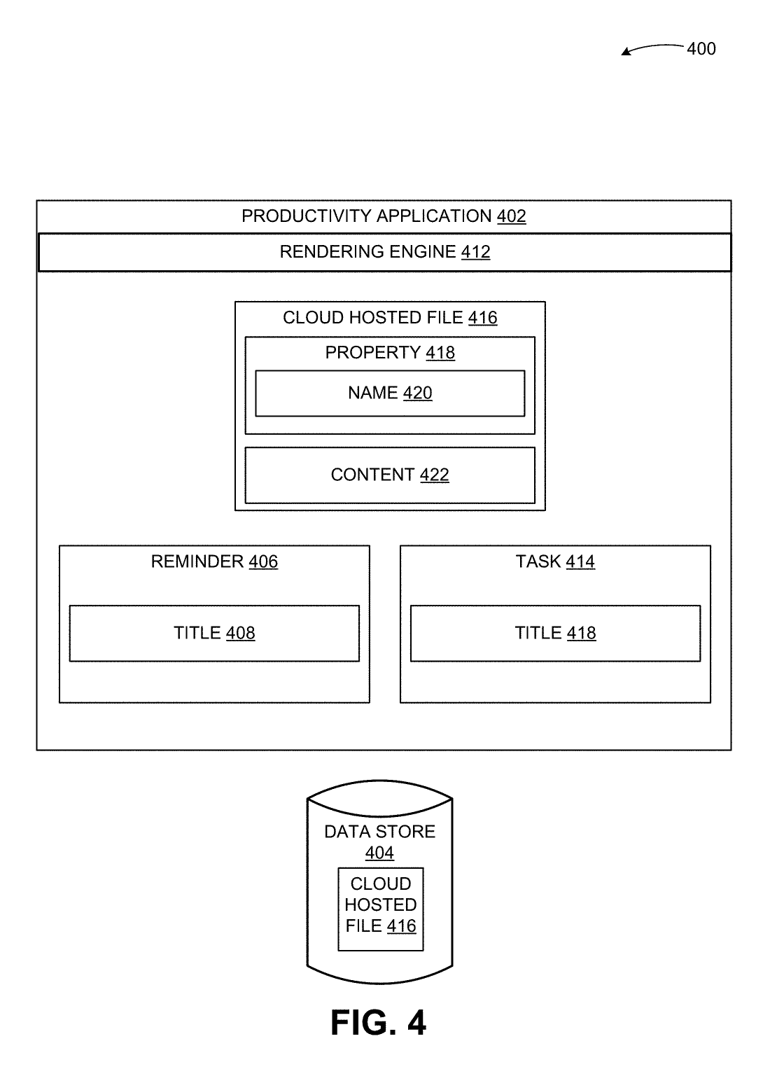

FIG. 4 is a display diagram illustrating another example scenario of the alternative scheme to provide document feature management in relation to a communication, according to embodiments.

In a diagram 400, a rendering engine 412 of a productivity application 402 may generate a reminder 406 based on a property 418 of the cloud hosted file 416. The reminder 406 may include an alert generated based on the cloud hosted file 416 For example, a title of the reminder 406 may be created based on a name 420 of the cloud hosted file 416. Alternatively, a content 422 of the cloud hosted file 416 may be analyzed to identify context information for generating the reminder 406. For example, the content 422 may describe an upcoming event for an editor of the cloud hosted file 416. The upcoming event may be detected as a context information which may be used to generate the reminder 406 to alert the editor about the upcoming event.

Furthermore, a task 414 may be generated based on the property 418 of the cloud hosted file 416. For example, a title 408 of the task 414 may be created based on the name 420 of the cloud hosted file 416. Alternatively, a content 422 of the cloud hosted file 416 may be analyzed to identify context information for generating the task 414. For example, the content 422 may describe a due date for an assignment. The due date for the assignment may be detected as a context information which may be used to generate the task 414.

A data store 404 may host both a communication and the cloud hosted file 416 that is related to the communication. The rendering engine 412 of the productivity application 402 may instruct the data store 404 to store the cloud hosted file 416. Furthermore, the rendering engine 412 may instruct the data store 404 to update cloud hosted file 416 based on an edit action or other action(s) provided by an editor of the cloud hosted file 416.

As discussed above, the productivity application may be employed to provide document feature management in relation to a communication. An increased user efficiency with the productivity application 102 may occur as a result of renaming an attachment file based on an a modification applied at a central provider such as a data store. Propagating the name change for the attachment file from the data store may allow for updates to the attachment file at client application(s) without downloading a local copy and modifying the local copy. Furthermore, a cloud hosted file may be automatically created and configured with a property of a communication. As such, automated document feature management may reduce processor load, increase processing speed, conserve memory, and reduce network bandwidth usage.

Embodiments, as described herein, address a need that arises from a lack of efficiency to provide document feature management in relation to a communication. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing document feature management in relation to a communication may be implemented in configurations employing fewer or additional components in applications and user interfaces. Furthermore, the example schema and components shown in FIG. 1 through 4 and their subcomponents may be implemented in a similar manner with other values using the principles described herein.

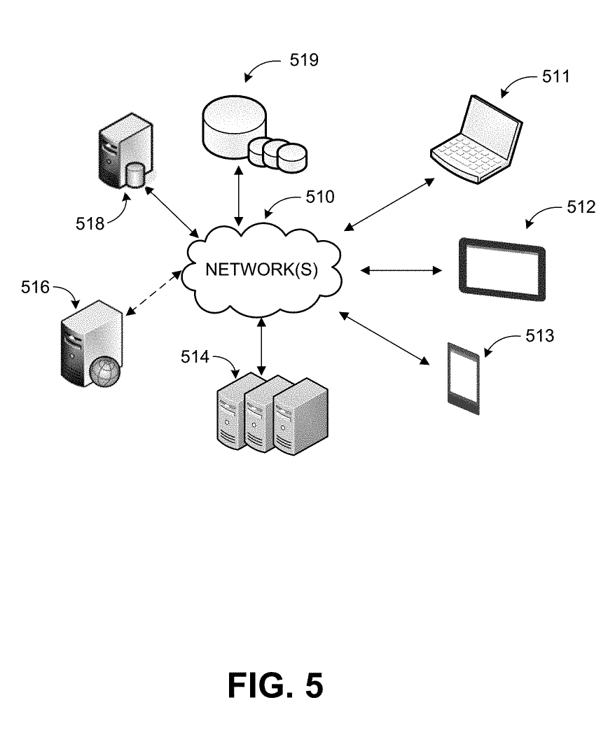

FIG. 5 is an example networked environment, where embodiments may be implemented. A productivity application configured to provide document feature management in relation to a communication may be implemented via software executed over one or more servers 514 such as a hosted service. The platform may communicate with client applications on individual computing devices such as a smart phone 513, a mobile computer 512, or desktop computer 511 (client devices') through network(s) 510.

Client applications executed on any of the client devices 511-513 may facilitate communications via application(s) executed by servers 514, or on individual server 516. A productivity application may present a communication through a productivity application UI. The communication may include an attachment file. Upon receiving a modification for the attachment, the attachment file may be renamed based on the modification. Next, an instruction may be transmitted to a data store associated with the communication to rename the attachment file based on the modification.

In an alternative scenario, the productivity application may receive a request to create a cloud hosted file associated with a communication. In response to the request, the cloud hosted file may be created in relation to the communication. Next, a property of the cloud hosted file may be configured based on a property of the communication. The cloud hosted file may also be associated with a group associated with the communication. The productivity application may store data associated with the attachment file and/or the cloud hosted file in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide document feature management in relation to a communication. Furthermore, the networked environments discussed in FIG. 5 are for illustration purposes only. Embodiments are not limited to the example applications, modules, or processes.

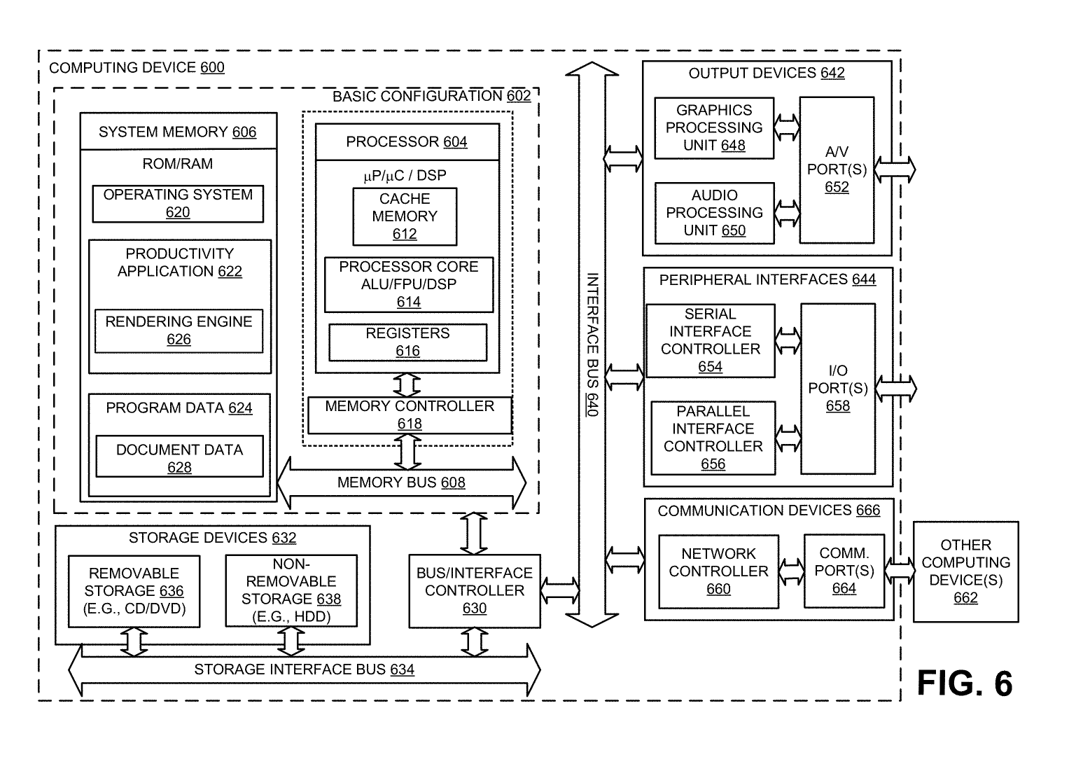

FIG. 6 is a block diagram of an example computing device, which may be used to provide document feature management in relation to a communication, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity application 622, and a program data 624. The productivity application 622 may include components such as a rendering engine 626. The rendering engine 626 may execute the processes associated with the productivity application 622. The rendering engine 626 may present a communication through a productivity application UI. The communication may include an attachment file. Upon receiving a modification for the attachment, the attachment file may be renamed based on the modification. Next, an instruction may be transmitted to a data store associated with the communication to rename the attachment file based on the modification.

In an alternative scenario, the rendering engine 626 of the productivity application 622 may receive a request to create a cloud hosted file associated with a communication. In response to the request, the cloud hosted file may be created in relation to the communication. Next, a property of the cloud hosted file may be configured based on a property of the communication. The cloud hosted file may also be associated with a group associated with the communication.

The productivity application 622 may display the attachment file and/or the cloud hosted file through a display component associated with the computing device 600. An example of the display component may include a monitor, and/or a touch screen, among others that may be communicatively coupled to the computing device 600. The program data 624 may also include, among other data, document data 628, or the like, as described herein. The document data 628 may include the attachment file and/or the cloud hosted file.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide document feature management in relation to a communication. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

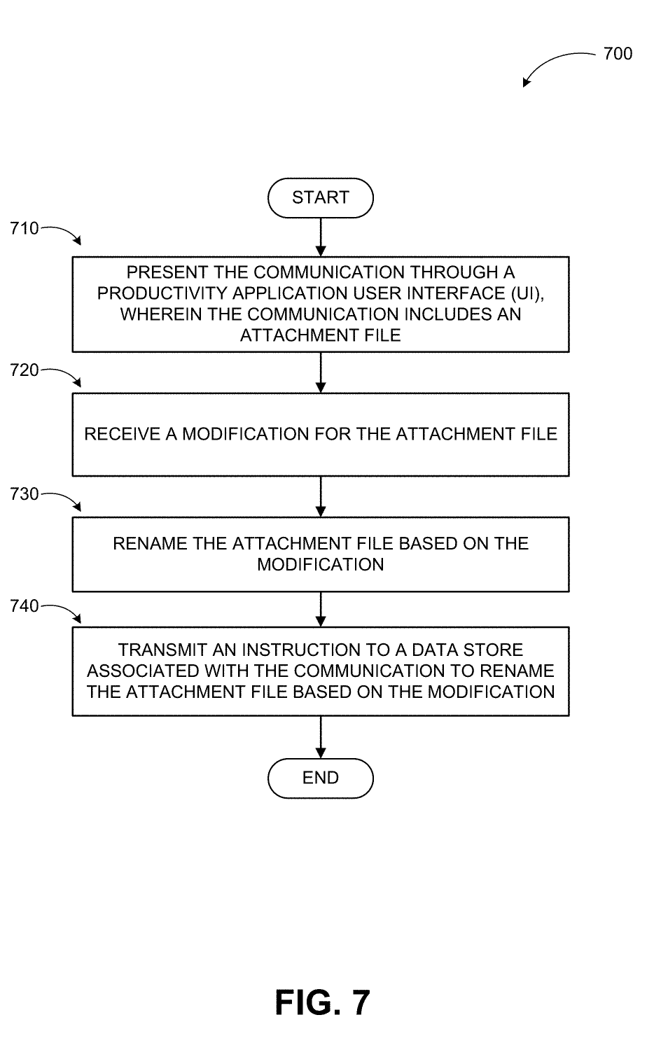

FIG. 7 is a logic flow diagram illustrating a process for providing a document feature management in relation to a communication, according to embodiments. Process 700 may be implemented on a computing device, such as the computing device 600 or another system.

Process 700 begins with operation 710, where the productivity application presents a communication through a productivity application UI. The communication may include an attachment file. An example of the attachment may include a document. At operation 720, the productivity application may receive a modification for the attachment. The modification may include an edit action provided by a recipient. At operation 730, the attachment file may be renamed based on the modification. Next, at operation 740, an instruction may be transmitted to a data store associated with the communication to rename the attachment file based on the modification.

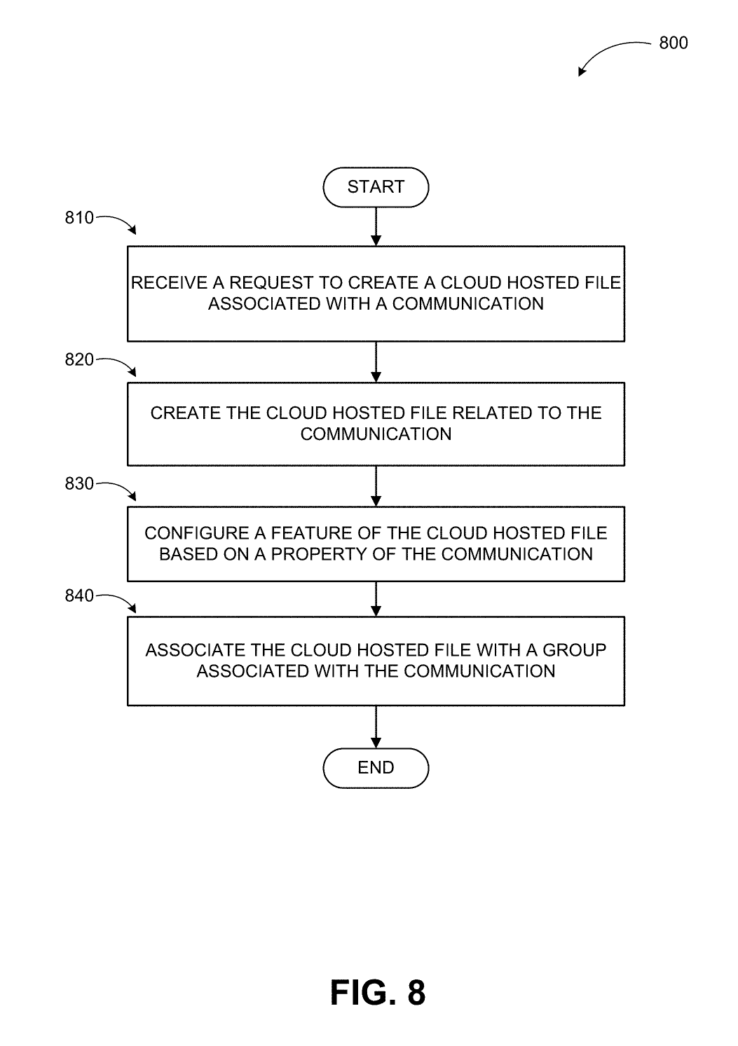

FIG. 8 is another logic flow diagram illustrating another process for providing document feature management in relation to a communication, according to embodiments. Process 800 may be implemented on a computing device, such as the computing device 600 or another system.

Process 800 begins with operation 810, where the productivity application receives a request to create a cloud hosted file associated with a communication. An example of the cloud hosted file may include a document hosted by a distributed computing source. At operation 820, in response to the request, the cloud hosted file may be created in relation to the communication. Next, at operation 830, a property of the cloud hosted file may be configured based on a property of the communication. At operation 840, the cloud hosted file may also be associated with a group associated with the communication.

The operations included in processes 700 and 800 are for illustration purposes. Providing document feature management in relation to a communication may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a method executed on a computing device to provide document feature management in relation to a communication is described. The method includes presenting the communication through a productivity application user interface (UI), where the communication includes an attachment file, receiving a modification for the attachment file, renaming the attachment file based on the modification, and transmitting an instruction to a data store associated with the communication to rename the attachment file based on the modification.

In other examples, where the data store hosts the attachment file. Renaming the attachment file further includes renaming a local cache of the attachment file and presenting the communication with the renamed local cache of the attachment file through the productivity application UI. The method further includes transmitting other instruction to the data store, where the other instruction instructs a client application, that provides the attachment file, to rename other local cache of the attachment file based on the modification.

In further examples, the method further includes providing an editable string as a name for the attachment file. The method further includes detecting an edit action on the editable string and applying the edit action as the modification to rename the attachment file. The method further includes detecting an activation of a menu element for renaming editable string, providing a UI element for renaming the editable string, detecting an action on the UI element, and applying the action as the modification to rename the attachment file.

In some examples, a method executed on a computing device to provide document feature management in relation to a communication. The method includes receiving a request to create a cloud hosted file associated with a communication, creating the cloud hosted file related to the communication, configuring a property of the cloud hosted file based on a property of the communication, and associating the cloud hosted file with a group associated with the communication.

In other examples, creating the group from one or more recipients associated with one or more of the communication and a conversation encompassing the communication. The method further includes granting the group an access privilege to modify the cloud hosted file. The method further includes generating a name of the cloud hosted file based on the property of the communication. The property of the communication includes a subject of the communication.

In further examples, the method further includes generating a reminder based on one or more of the property of the cloud hosted file and a content of the cloud hosted file. The method further includes creating a title of the reminder based on the property of the cloud hosted file. The method further includes generating a task based on one or more of the property of the cloud hosted file and a content of the cloud hosted file. The method further includes creating a title of the task based on the property of the cloud hosted file. The method further includes instructing a data store associated with the communication to store the cloud hosted file in an association with the communication.

In some examples, a computing device to provide document feature management in relation to a communication. The computing device further includes a display component, a memory configured to store instructions associated with a productivity application, a processor coupled to the memory and the display component. The processor executes the productivity application in conjunction with the instructions stored in the memory. The productivity application includes a rendering engine. The rendering engine is configured to receive a request to create a cloud hosted file associated with an email, create the cloud hosted file related to the email, configure a property of the cloud hosted file based on a property of the email, where the property includes a subject of the email, associate the cloud hosted file with a group of one or more recipients associated with the email, and grant the group an access privilege to modify the cloud hosted file.

In other examples, the rendering engine is further configured to generate a name of the cloud hosted file based on the subject of the email. The rendering engine is further configured to generate a reminder based on a name of the cloud hosted file and a content of the cloud hosted file and establish a title of the reminder based on the name of the cloud hosted file.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide document feature management in relation to a communication, the method comprising:
presenting the communication through a productivity application user interface (UI), wherein the communication includes an attachment file;
receiving a modification for the attachment file;
renaming the attachment file based on the modification; and
transmitting an instruction to a data store associated with the communication to rename the attachment file based on the modification.

2. The method of claim 1, wherein the data store hosts the attachment file.

3. The method of claim 1, wherein renaming the attachment file further comprises:
renaming a local cache of the attachment file; and
presenting the communication with the renamed local cache of the attachment file through the productivity application UI.

4. The method of claim 1, further comprising:
transmitting other instruction to the data store, wherein the other instruction instructs a client application, that provides the attachment file, to rename other local cache of the attachment file based on the modification.

5. The method of claim 1, further comprising:
providing an editable string as a name for the attachment file.

6. The method of claim 5, further comprising:
detecting an edit action on the editable string; and
applying the edit action as the modification to rename the attachment file.

7. The method of claim 5, further comprising:
detecting an activation of a menu element for renaming editable string;
providing a UI element for renaming the editable string;
detecting an action on the UI element; and
applying the action as the modification to rename the attachment file.
